(19) United States
(12) Patent Application Publication
(10) Pub. No.: US 2023/0001767 A1
(43) Pub. Date: Jan. 5, 2023

(54) ELECTRICAL HEATING DEVICE AND POSITIONING ELEMENT ASSOCIATED WITH SAME

(71) Applicant: Valeo Systemes Thermiques, Le Mesnil Saint-Denis (FR)

(72) Inventors: Romain Delcourt, Le Mesnil Saint-Denis (FR); Théo Deletang, Le Mesnil Saint-Denis (FR); Pascal Fourgous, Le Mesnil Saint-Denis (FR)

(73) Assignee: Valeo Systemes Thermiques, Le Mesnil Saint-Denis (FR)

(21) Appl. No.: 17/780,615

(22) PCT Filed: Nov. 10, 2020
(86) PCT No.: PCT/FR2020/052047

§ 371 Date: May 27, 2022

(30) Foreign Application Priority Data
Nov. 28, 2019 (FR) FR1913364

(51) Int. Cl. B60H 1/22; H05B 1/02

(52) U.S. Cl. CPC B60H 1/2218; B60H 1/2225; H05B 1/0236; H05B 2203/023; B60H 2001/2278

(57) ABSTRACT

The invention relates to an electrical heating device (1), in particular for a motor vehicle, the device (1) comprising: —a heating element (3) supplied with power at high voltage, —a control unit (5) supplied with power at low voltage and configured to receive a low-voltage electrical signal, the control unit (5) comprising at least one printed circuit (12) with at least one surface configured to receive electronic components; —at least one transmission cable (10) configured to transmit the low-voltage electric signal to the control unit (5), characterised in that the control unit (5) comprises at least one positioning element (20) configured to position the transmission cable (10) inside the control unit (5) and in that the positioning element (20) comprises at least one electrically insulating material.

The present invention relates to the field of ventilation, heating and/or air conditioning for motor vehicles, and more particularly relates to an electric heating device such as an electric heater.

Such electric heating devices sometimes use a high-voltage power supply network, in particular in the case of electric or hybrid vehicles. The electric heaters are, for example, supplied with power at a high voltage in order to deliver a high level of thermal power so as to be used as an additional heat source or even as a main heating device when the power delivered is sufficient to heat the air in the ventilation, heating and/or air-conditioning system.

Such electric heating devices are, for example, intended to be supplied with power by a direct or alternating current at a voltage higher than 60 V, in particular between 60 V and 1000 V, more particularly between 180 V and 600 V, and/or allowing heating power to be released into the air, or having electrical power consumption of more than 2 kW, in particular between 2 kW and 10 kW.

These electric heating devices, such as electric heaters, generally comprise a heating body provided with heating elements which are, for example, arranged so as to be directly exposed to an air flow through the electric heating device. The heating elements comprise, for example, PTC (positive temperature coefficient) ceramic or stone. These are elements whose resistance varies greatly as a function of temperature. More precisely, the ohmic value of the PTC resistive elements increases very rapidly beyond a predetermined temperature threshold.

Particularly in the case of an electric heating device supplied with power at a high voltage, this device may be a main heating device of the vehicle which may be very powerful, which involves having to deliver very high levels of electrical power, in particular of the order of 1 kW to 8 kW. In the event of overheating, the device may reach at at least one point a temperature limit for the correct operation of said device. By its nature, PTC stone or ceramic provides protection against excessive overheating which could, for example, start a fire, thereby ensuring passenger safety.

In addition, such heating devices generally comprise a control unit capable of controlling the current flowing through the heating elements via, in particular, an electrical power supply circuit on a control circuit board, such as a printed circuit board (PCB). The electrical and electronic components of such a control unit generally operate at a low voltage. The low voltage may, for example, be of the order of 12 V to 48 V.

However, certain components of the low-voltage network, such as transmission cables used, for example, to send information from a measurement sensor to a control unit or a processing unit or any other component of the low-voltage network located close to the high-voltage components, may be more sensitive and be negatively affected or even damaged under certain conditions, for example in the case of extended exposure to a high electromagnetic field. It is therefore important to protect components operating at a low voltage from the influence of components supplied with power at a high voltage in order to prevent their potential deterioration over time.

The objective of the invention is to at least partially mitigate these drawbacks of the prior art by providing a straightforward and economical solution.

To that end, the subject of the invention is an electric heating device, in particular for a motor vehicle, said device comprising a heating body supplied with power at high voltage, a control unit supplied with power at low voltage, the control unit being configured to receive a low-voltage electrical signal, the control unit comprising at least one printed circuit board with at least one surface configured to accommodate electronic components; at least one transmission cable configured to transmit the low-voltage electrical signal to the control unit, the electric heating device being characterized in that the control unit comprises at least one positioning element configured to position the transmission cable within the control unit and in that the positioning element comprises at least one electrically insulating material.

Such a positioning element made of electrically insulating material protects the transmission cable by preventing current and heat from passing through the material of the positioning element. The positioning element also acts as a barrier to the propagation of the electric and/or magnetic fields generated by the other electronic components arranged on the printed circuit board of the control unit. Thus, at least a portion of the transmission cable is protected from electromagnetic interference which may result in interference in the one or more electrical signals carried by the transmission cable to the control unit. The positioning element guides the transmission cable in such a way as to prevent unwanted movement of the transmission cable with respect to the other components of the control unit. The positioning element thus serves both as a profiled guide and as a protective device for the transmission cable.

Said device may also have one or more of the following features, considered separately or in combination.
the positioning element is positioned at the edge of the printed circuit board;
the positioning element is a guide rail;
the at least one positioning element comprises two lateral walls connected to one another by a bottom wall;
the inner surfaces of said lateral walls and of said bottom wall together delimit a housing volume comprising an opening;
the housing volume is configured to accommodate the transmission cable portion therein;
the control unit comprises a casing with an open face;
the positioning element is located on the face of the printed circuit board oriented facing the open face of the casing of the control unit;
the electric heating device comprises a cover arranged on the open face of the casing so as to close said casing;
the cover of the control unit is configured to cover the opening of the housing volume of the positioning element;
at least one of the lateral walls comprises at least one retaining protuberance that protrudes with respect to the inner surfaces of the lateral walls of the positioning element;
the at least one retaining protuberance is arranged at a distance from the bottom wall such that the distance separating the inner surface of the bottom wall from the at least one retaining protuberance is greater than the radius of the transmission cable;
the at least one retaining protuberance is arranged on a free edge of at least one lateral wall;
a plurality of retaining protuberances are arranged in a staggered manner on the lateral walls of the positioning element;
the at least one retaining protuberance is made as one piece with the positioning element;
the at least one retaining protuberance is a part added to the positioning element;
at least one of the lateral walls comprises perforated attachment lugs whose perforations are superimposed over the attachment perforations of the printed circuit board within the control unit;
the positioning element is bonded to the printed circuit board of the control unit.

Further advantages and features of the invention will become more clearly apparent from reading the following description, given by way of illustrative and non-limiting example, and the appended drawings, in which:

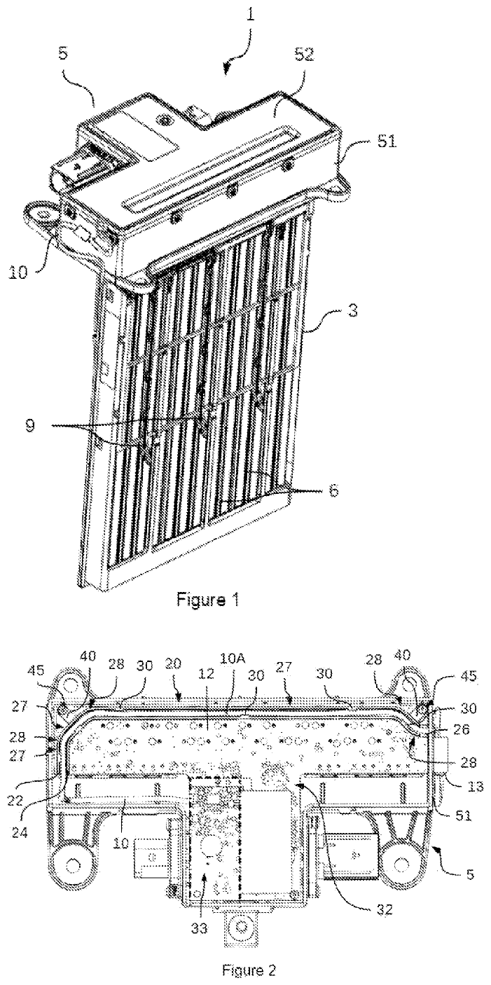

FIG. 1 shows a perspective view of an electric heating device according to an embodiment of the invention;

FIG. 2 is a perspective view of the control unit of the electric heating device of FIG. 1;

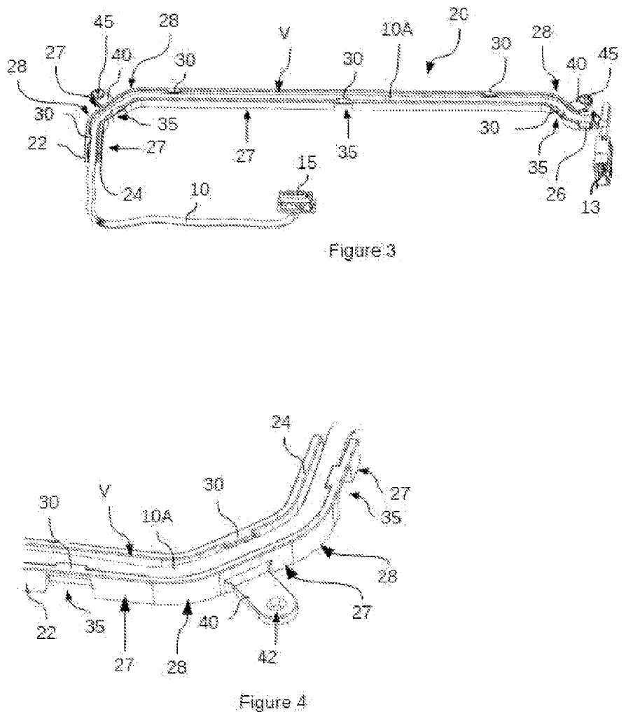

FIG. 3 is a perspective view of the positioning element of the control unit of FIG. 2;

FIG. 4 is a detail view of the positioning element of FIG. 3.

In these figures, identical elements bear the same reference numerals.

The following embodiments are examples. Although the description refers to one or more embodiments, this does not necessarily mean that each reference relates to the same embodiment, or that the features apply only to a single embodiment. Individual features of various embodiments may also be combined or interchanged in order to create other embodiments.

In the description, certain elements may be indexed, such as first element or second element. In this case, this is merely indexing for differentiating and denoting elements that are similar but not identical. This indexing does not imply that one element takes priority over another and such denominations can easily be interchanged without departing from the scope of the present description. This indexing does not imply an order in time either.

With reference to FIG. 1, the invention relates to an electric heating device 1, in particular of a heating and/or ventilation and/or air-conditioning system for a motor vehicle. In particular, it is a device 1 for heating a fluid such as an air flow. Such an electric heating device 1 may be arranged for an air flow to be heated to pass therethrough. Below, the description is given with reference to an air flow, but the invention may be applied to another fluid. As a variant, it could be a device for heating water.

According to one embodiment illustrated in FIGS. 1 to 4, it may, in particular, be a “high-voltage” electric heating device 1 allowing heating power to be released into the air or a consumed electrical power higher than 2 kW, in particular between 2 kW and 10 kW. What is meant by “high voltage”, in this context is a voltage higher than 60 V, in particular between 60 V and 1000 V, more particularly between 180 V and 600 V.

The electric heating device 1 is, for example, capable of transforming electrical energy drawn, for example, from the motor vehicle into thermal energy which is transferred to the air flow through the heating device 1. To that end, the electric heating device 1 comprises a heating body 3 intended to be supplied with electric current at high voltage in order to heat the air flow through the heating body 3.

The heating body 3 may, in particular, comprise at least one measurement sensor 9 such as a temperature sensor 9 for measuring the temperature of the one or more air flows exiting the heating body 3. In the example illustrated in FIG. 1, three temperature sensors 9 are provided in order to measure the temperature of the one or more air flows at various points on the heating body 3, in particular at the heating units 6.

These may be analog temperature sensors 9. The temperature sensors 9 may, for example, be embodied by thermistors, such as NTC (negative temperature coefficient) resistive elements. Alternatively, they may be digital temperature sensors 9.

The electric heating device 1 comprises a control unit 5 for the heating body 3. The control unit 5 is supplied with power at low voltage and is configured to receive a low-voltage electrical signal. The low voltage may, for example, be of the order of 12 V to 48 V. The control unit 5 comprises, for example, a casing 51 forming a housing with an open face. The casing 51 accommodates, in this housing, electronic components (FIG. 2) which are configured to receive and process information in order to generate a control instruction for driving the heating body 3. The electric heating device also comprises a cover 52 arranged on the open face of the casing 51 so as to close said casing 51.

The control unit 5 thus comprises, in this housing, at least one printed circuit board 12 which comprises at least one face configured to accommodate electronic components. According to one embodiment (not illustrated), both faces of the printed circuit board 12 may be configured to accommodate electronic components.

In the example illustrated in FIG. 2, the printed circuit board 12 has a first face oriented facing the open face of the casing 51 of the control unit 5. The printed circuit board 12 also comprises a second face comprising the electronic components, this second face being arranged opposite the open face of the casing 51 of the control unit 5. For the sake of clarity, the cover 52 has been omitted from FIG. 2.

The control unit 5 may be divided into two regions, a high-voltage region 32 and a low-voltage region 33. In FIG. 2, the border between the two regions is represented by a dashed line.

The control unit 5 is, in particular, configured to receive data from the at least one measurement sensor 9 via at least one transmission cable 10. In other words, the at least one transmission cable 10 is configured to transmit data, such as temperature measurements, between the at least one measurement sensor 9 and the control unit 5. More precisely, each measurement sensor 9 of the heating body 3 is electrically connected to the printed circuit board 12 arranged within the control unit 5 in order to communicate data which are processed with a view to controlling the corresponding heating units 6.

The transmission cable 10 connects, for example, a first connector 13 (FIG. 3) to which the at least one measurement sensor 9 is connected to a second connector 15 arranged on one of the faces of the printed circuit board 12 in the low-voltage region 33. In the example illustrated in FIG. 2, the second connector 15 is placed on the second face of the printed circuit board 12, that is to say the face comprising the electronic components. The voltage within the transmission cable 10 is a low voltage; it is, for example, of the order of 5 V.

On its way from the first connector 13 to the second connector 15, a portion 10A of the transmission cable 10 passes, for example, over the first face of the printed circuit board 12 (FIG. 2) oriented toward the open face of the casing 51 of the control unit 5 which is intended to be covered by the cover 52. According to one embodiment (not illustrated), the transmission cable 10 passes over the second face of the printed circuit board 12, that is to say the face of the printed circuit board 12 opposite that oriented toward the open face of the casing 51 of the control unit 5.

The transmission cable 10 may, in particular, pass through the high-voltage region 32 where it is especially exposed to electromagnetic fields. The transmission cable 10, or at least the portion 10A of the transmission cable 10 is thus substantially exposed to the electromagnetic fields given off by the electronic components, in particular those attached to the printed circuit board 12. The presence of electromagnetic fields given off by these components may negatively affect the quality of the signal traveling through the transmission cable 10 between the measurement sensor 9 and the printed circuit board 12.

In order to protect the transmission cable 10 from the influence of these electronic components, the control unit 5 comprises at least one positioning element 20 (FIG. 2) configured to position the transmission cable 10 within the control unit 5. The positioning element 20 comprises at least one electrically insulating material which, in particular, prevents current and heat from passing through the material of the positioning element 20 and acts as a barrier against the propagation of electric and/or magnetic fields.

The electrically insulating material of the positioning element 20 ensures the electromagnetic compatibility of the transmission cable 10 by ensuring that it operates adequately in the electromagnetic environment to which it is exposed. The positioning element 20 is, in particular, configured to limit the unwanted reception of electromagnetic energy which may lead to undesirable effects such as electromagnetic interference (EMI), deterioration of the transmitted signal or even physical damage within the transmission cable 10.

The positioning element 20 is, in particular, located on the face of the printed circuit board 12 oriented facing the open face of the casing 51 of the control unit 5. The positioning element 20 may, in particular, be a guide rail which positions and guides the transmission cable 10 within the control unit 5.

In the case where the positioning element 20 takes the form of a guide rail, it comprises, for example, three walls 22, 24 and 26 and, more particularly, two lateral walls 22 and 24 connected to one another by a bottom wall 26, as shown in FIG. 3. The lateral walls 22 and 24 are, for example, parallel to one other while the plane of the bottom wall 26 extends perpendicular to the lateral walls 22 and 24. The positioning element 20 thus has, for example, a “U”-shaped cross section. By way of example, the thickness of the lateral walls 22 and 24 and of the bottom wall 26 is, in particular, between one and three millimeters.

The inner surfaces of the lateral walls 22 and 24 and of the bottom wall 26 together delimit a housing volume V configured to accommodate therein the portion 10A of the transmission cable 10. The housing volume V therefore comprises an opening which is not obstructed by the walls 22, 24 and 26 of the positioning element 20. This opening allows the portion 10A of the transmission cable 10 to be inserted into the housing volume V.

According to the embodiment of the positioning element 20 illustrated in FIG. 2, the positioning element 20 is positioned at the edge of the printed circuit board 12, so as to run along the walls of the casing 51 of the control unit 5, thereby freeing up space in the center of the latter. In this same figure, the positioning element 20 is shown in the form of a guide rail placed on the face of the printed circuit board 12 oriented toward the open face of the casing 51 of the control unit 5.

The cover 52 of the control unit 5 may, in particular, be configured to cover the opening of the housing volume V of the positioning element 20. One face of the cover 52 is, for example, in contact with the free edges of the lateral walls 22 and 24 of the positioning element 20. What is meant by “free edge” is the edge of a lateral wall 22 and/or 24 which delimits the opening of the positioning element 20. According to another example, there may be a clearance between said face of the cover 52 and the free edges of the lateral walls 22 and 24 of the positioning element 20. The cover 52 comprises, for example, a relief whose shape is complementary to the free edges of the lateral walls 22 and 24, such that part of the relief covers these free edges. The relief of the cover 52 makes it possible to prevent the portion 10A of the transmission cable 10 from accidentally coming out of the housing volume V. It may also act as a guide for positioning the cover 52 on the casing 51, in particular in a step of assembling the control unit 5.

When it is inserted into the housing volume V of the positioning element 20, the portion 10A of the transmission cable 10 conforms to the shape of the positioning element 20. The positioning element 20 comprises, for example, multiple straight portions 27 connected to one another by bent portions 28 (FIG. 3). The straight portions 27 may, in particular, have different lengths and the bent portions 28 have, for example, radii of curvature that are distinct from each other. As a variant, the radii of curvature of some bent portions 28 may be identical. As a precaution, to avoid exerting mechanical stresses on the transmission cable 10 which might damage it, the radii of curvature of the bent sections 28 are at least equal to three times the diameter of the transmission cable 10.

According to one embodiment of the positioning element 20 illustrated in FIG. 3, the positioning element 20 comprises, for example, three straight portions 27 of various lengths connected to one another by bent portions 28. The general shape of the positioning element 20 resulting from the alternation between the straight portions 27 and the bent portions 28 is, for example, that of a “C”. The portion 10A of the transmission cable 10 is constrained to follow the geometry of the straight sections 27 and of the bent sections 28, so as to run along the edge of the first face of the printed circuit board 12 in the casing 51, as illustrated in FIG. 2.

There may be a lateral clearance between the inner surfaces of the lateral walls 22 and 24 and the portion 10A of the transmission cable 10. There may likewise be a clearance between the bottom wall 26 and the transmission cable 10 portion. The clearances are tight enough to prevent the portion 10A of the transmission cable 10 from accidentally coming out of the housing volume V of the positioning element 20, for example under the effect of an impact. However, the clearances are wide enough to avoid squeezing of the portion 10A of the transmission cable 10. In other words, the walls 22, 24 and 26 of the positioning element 20 are dimensioned in such a way that the portion 10A of the transmission cable 10 is guided over the printed circuit board 12 without being squeezed.

In order to keep the portion 10A of the transmission cable 10 inside its housing volume V even in the absence of the cover 52 of the control unit 5, at least one of the lateral walls 22 or 24 may comprise at least one retaining protuberance 30 that protrudes with respect to the inner surfaces of the lateral walls 22, 24 of the positioning element 20, as shown in FIG. 3. According to the embodiment of the positioning element 20 illustrated in FIGS. 2 and 3, both lateral walls 22 and 24 of the positioning element 20 comprise multiple retaining protuberances 30 protruding toward the interior of the positioning element 20.

The retaining protuberances 30 are, for example, parallelepipedal in shape, the longest dimension of which extends parallel to the lateral walls 22, 24. The longest dimension of a retaining protuberance 30 is, for example, of the same order of magnitude as the gap separating the lateral walls 22 and 24. In other words, the longest dimension of a retaining protuberance 30 is substantially smaller than the longitudinal dimension of the positioning element 20.

The retaining protuberances 30 are, in particular, configured to keep the portion 10A of the transmission cable 10 inside the housing volume V and to prevent the portion 10A of the transmission cable 10 from accidentally coming out of the housing volume V of the positioning element 20. With this in mind, the retaining protuberances 30 are arranged at a distance from the bottom wall 26, such that the distance separating the inner surface of the bottom wall 26 from the retaining protuberances 30 is greater than the radius of the transmission cable 10.

More particularly, the retaining protuberances 30 are, for example, arranged on a free edge of at least one lateral wall 22 and/or 24. In the case where the retaining protuberances 30 are thus arranged on the free edges of the lateral walls 22 and 24, the size of the housing volume V is maximum, thereby allowing a portion 10A of the transmission cable 10 with a large diameter, for example of the order of the gap between the inner surfaces of the lateral walls 22 and 24, to be accommodated without risk of squeezing the portion 10A of the transmission cable 10.

A plurality of retaining protuberances 30 may be arranged in a staggered manner on the lateral walls 22 and 24 of the positioning element 20 as shown in FIGS. 3 and 4. In other words, the locations of the retaining protuberances 30 are shared in alternation between the two lateral walls 22 and 24 of the positioning element 20. Such a staggered arrangement allows a balanced distribution of the retaining protuberances 30 along the free edges of the lateral walls 22 and 24 in order to secure the portion 10A of the transmission cable 10 inside the housing volume V. The number of retaining protuberances 30 is, for example, between three and ten, and is more particularly equal to six.

According to a first embodiment of these retaining protuberances 30, the latter are made as one piece with the positioning element 20. These retaining protuberances 30 may thus be obtained in a process of molding or injecting the positioning element 20. In the case of a molding production process, openings 35 are provided in the lateral walls 22 and 24 at the locations of the retaining protuberances 30 so as to allow them to be formed during the production of the positioning element 20 by molding. Such a process for producing the positioning element 20 is, for example, a solution that is inexpensive and easy to implement on a production line.

According to a second embodiment (not illustrated) of the retaining protuberances 30, they are parts that are added to the positioning element 20. In this case, the retaining protuberances 30 take the form, for example, of parallelepipedal plastic rods which are attached, for example by bonding, to the inner faces of the lateral walls 22 and 24 of the positioning element 20, so as to be adjacent to the free edges of the lateral walls 22 and 24.

In the case where the retaining protuberances 30 are added parts, the openings 35 in the lateral walls 22 and 24 may be omitted, since they are not needed in the production of the positioning element 20 by molding for this particular embodiment.

To position the positioning element 20 with respect to the printed circuit board 12 inside the casing 51, at least one of the lateral walls 22 or 24 may comprise perforated attachment lugs 40 whose perforations 42 (FIG. 4) are superimposed over attachment perforations of the printed circuit board 12 within the control unit 5 (FIG. 2). According to one embodiment of the positioning element 20 illustrated in FIGS. 2 to 4, only the lateral wall 22 may comprise the attachment lugs 40. Each attachment lug 40 comprises, for example, at least one perforation 42 configured to accommodate a screw 45 (FIG. 2) therein allowing the positioning element 20 to be positioned with respect to the casing 51 while attaching the positioning element 20 to the face of the printed circuit board 12 oriented toward the open face of the casing 51 of the control unit 5.

The positioning element 20 comprises, for example, between two and six attachment lugs 40 which may be distributed regularly along the positioning element 20 or be located at strategic locations on the positioning element 20. According to the embodiment of the positioning element 20 illustrated in FIG. 3, the attachment lugs 40 are arranged on two very short straight portions 27 of the positioning element 20 that are located between two curved portions 28, which are themselves located at the corners of the casing 51 of the control unit 5 (FIG. 2). The attachment lugs 40 protrude, for example, with respect to the outer face of the lateral wall 22, as illustrated in FIG. 4. The attachment lugs 40 are oriented perpendicular to the outer surface of the lateral wall 22. According to one variant of the positioning element 20 not illustrated in the figures, the attachment lugs 40 may be positioned on the lateral wall 24.

The attachment lugs 40 allow the positioning element 20 to be positioned and steadied inside the casing 51 of the control unit 5 (FIG. 2). This makes it possible, in particular, to prevent the positioning element 20 from vibrating as caused, for example, when the motor vehicle in which the electric heating device 1 is installed is driven.

According to another non-illustrated embodiment of the positioning element 20, it may be bonded to the printed circuit board 12 of the control unit 5. More particularly, it is permanently attached to the face of the printed circuit board 12, thereby making it possible to keep vibrating of the positioning element 20 to a minimum.

The materials that may be envisaged for producing such a positioning element 20 are, for example, composite materials comprising glass fibers in a thermoplastic polymer structure, such as PBT GF20 or PA66 GF20-30. The main characteristics of composite materials such as nylons filled with glass fibers are, in particular, very high rigidity, high mechanical strength, a high degree of hardness and solidity as well as very good resistance to creep. Nylons filled with glass fibers also exhibit high dimensional stability, good resistance to fatigue and very good mechanical damping properties.

In general, the materials that may be envisaged for the positioning element 20 are mechanically compatible with the external environment, namely that of an electric heating device 1 in this specific case. The positioning element 20 has, for example, a coefficient of thermal expansion that is compatible with its environment. More precisely, the walls 22, 24 and 26 of the positioning element 20 are, for example, designed in such a way that their thicknesses change little with temperature. In the case of variations in the thickness of the walls 22, 24 and 26 of the positioning element 20 following changes in temperature, these do not result in thermomechanical stresses on the portion 10A of the transmission cable 10 so that it is not squeezed or otherwise damaged.

The material of the positioning element 20 may, for example, resist heat transfer, thereby limiting exposure of the portion of the transmission cable 10 to sudden temperature changes or more generally to an undesirable rise in temperature. In addition, the material of the positioning element 20 may be fireproofed, thereby limiting flame propagation in the event of a fire.

The positioning element 20 thus protects the at least one portion 10A of the transmission cable 10 both from electromagnetic radiation from surrounding parts of the control unit 5 and from external mechanical and/or thermal stresses such as vibrations or a rise in temperature that the electric heating device 1 may experience.

1. An electric heating device for a motor vehicle, said device comprising:
a heating body supplied with power at high voltage;
a control unit supplied with power at low voltage and configured to receive a low-voltage electrical signal, the control unit comprising at least one printed circuit board with at least one surface configured to accommodate electronic components;
at least one transmission cable configured to transmit the low-voltage electrical signal to the control unit
wherein the control unit comprises at least one positioning element configured to position the transmission cable within the control unit and
wherein the positioning element comprises at least one electrically insulating material.

2. The electric heating device as claimed in claim 1, wherein the positioning element is arranged at the edge of the printed circuit board.

3. The electric heating device as claimed in claim 1, wherein the positioning element is a guide rail.

4. The electric heating device as claimed in claim 3, wherein the at least one positioning element comprises two lateral walls connected to one another by a bottom wall and wherein the inner surfaces of said lateral walls and of said bottom wall together delimit a housing volume, the housing volume being configured to accommodate the transmission cable therein.

5. The electric heating device as claimed in claim 4, wherein the control unit comprises a casing with an open face, the positioning element being located on the face of the printed circuit board oriented facing the open face of the casing of the control unit, the electric heating device comprising a cover arranged on the open face of the casing so as to close said casing and configured to cover the opening of the housing volume of the positioning element.

6. The electric heating device as claimed in claim 4, wherein at least one of the lateral walls comprises at least one retaining protuberance that protrudes with respect to the inner surfaces of the lateral walls of the positioning element and in that the at least one retaining protuberance is arranged at a distance from the bottom wall such that the distance separating the inner surface of the bottom wall from the at least one retaining protuberance is greater than the radius of the transmission cable.

7. The electric heating device as claimed in claim 6, wherein the at least one retaining protuberance is arranged on a free edge of at least one lateral wall.

8. The electric heating device as claimed in claim 6, wherein a plurality of retaining protuberances are arranged in a staggered manner on the lateral walls of the positioning element.

9. The electric heating device as claimed in claim 4, wherein at least one of the lateral walls comprises perforated attachment lugs whose perforations are superimposed over attachment perforations of the printed circuit board within the control unit.

10. The electric heating device as claimed in claim 1, wherein the positioning element is bonded to the printed circuit board of the control unit.
